(19) United States
(12) Patent Application Publication
(10) Pub. No.: US 2013/0006889 A1
(43) Pub. Date: Jan. 3, 2013

(54) Compliance and credit attribute system and method

(76) Inventors: Gregg L. Bienstock, Larchmont, NY (US); Timothy J. Stevens, Stamford, CT (US)

(21) Appl. No.: 13/532,395

(22) Filed: Jun. 25, 2012

Related U.S. Application Data
(60) Provisional application No. 61/501,011, filed on Jun. 24, 2011.

(51) Int. Cl. G06Q 40/06

(52) U.S. Cl. 705/36 R

(57) ABSTRACT

A computer system and method for managing information related to compliance and credit attribution for fixed income securities. A computer system identifies CUSIP information for securities included in a user fixed income security portfolio and retrieves bond attribute information for the identified CUSIP information along with economic and demographic data. Risk credit notices are identified for the CUSIP information and a user report is generated indicating the retrieved bond attribute information, economic and demographic data and identified risk credit notices for the identified CUSIP information.

### CROSS REFERENCE TO RELATED APPLICATIONS

This application claims priority to U.S. Application No. 61/501,011, filed Jun. 24, 2011, which is hereby incorporated by reference in its entirety.

### COPYRIGHT NOTICE

A portion of the disclosure of this patent document contains material which is subject to copyright protection. The copyright owner has no objection to the facsimile reproduction by any one of the patent disclosure, as it appears in the U.S. Patent and Trademark Office patent files or records, but otherwise reserves all copyright rights whatsoever.

### FIELD OF THE INVENTION

The invention relates to a computer implemented method and data processing system for analyzing demographic, economic, financial and political data relating to financial assets, and more specifically, to a computer implemented method and system that provides specific information and financial data relative to a CUSIP.

### BACKGROUND OF THE INVENTION

Presently, many software companies have developed and marketed financial analysis software packages. The functionality, prices and target markets of these packages has varied significantly. One commonality of these financial packages is a lack of multi-dimensional financial reporting and in particular the analysis designed to provide meaningful insight to the owner or manager of the analyzed financial assets.

The reporting of financial information typically takes two forms, namely reports containing figures (single dimensional); and graphic depictions of these figures (dual dimensional). Both forms usually represent a one or two dimensional, static and historical view of one particular segment regarding the subject analyzed financial asset.

Accordingly, there exists a need for a system for providing improved reporting of financial information relating to a financial asset to enable improved analysis for identifying at least exposure risks and opportunities.

### SUMMARY OF THE INVENTION

The present invention system and method provides users attribution and abstract information relative to a CUSIP and provides a compliance and attribution tool within the fixed income municipal market. In one aspect, the present invention system and method may be coupled with FINRA, MSRB and other regulatory bodies. In another aspect, the present invention provides dynamic economic, demographic users bond feature, key terms, structural information, location, access to Official Statements and Financial Information, identification of all material event and continuing disclosure filings for a past time period (e.g., twelve months), default information, credit ratings, pricing history, news elated to the issuer or location, potential conflict of interest information and financial data relevant to a sector assigned individual CUSIP. A further aspect of the invention is it provides backend tracking of activities taken by the user and a reporting feature for the compliance administrator.

It is noted an advantage of the invention is it solves the problem of aggregating divergent information and data so as to enable users access to substantive information regarding any: fixed income municipal bond, addresses compliance required or suggested mandates, and provides relevant sector-based data that is dynamic and current.

### BRIEF DESCRIPTION OF THE DRAWINGS

The objects and features of the invention can be understood with reference to the following detailed description of an illustrative embodiment of the present invention taken together in conjunction with the accompanying drawings in which:

FIG. 1 illustrates a computing system configured and operative for use with the present invention;

FIGS. 2A-2W illustrate an exemplary report and screen shots generated by the present invention in accordance with an illustrated embodiment; and

FIGS. 3A-3G, illustrate a system diagram depicting the operating components of a credit administrator dashboard shown for instance in FIGS. 3B-3G in accordance with an embodiment of the invention.

### WRITTEN DESCRIPTION OF CERTAIN EMBODIMENTS OF THE INVENTION

The present invention is now described more fully with reference to the accompanying drawings, in which an illustrated embodiment of the present invention is shown. The present invention is not limited in any way to the illustrated embodiment as the illustrated embodiment described below is merely exemplary of the invention, which can be embodied in various forms, as appreciated by one skilled in the art. Therefore, it is to be understood that any structural and functional details disclosed herein are not to be interpreted as limiting, but merely as a basis for the claims and as a representative for teaching one skilled in the art to variously employ the present invention. Furthermore, the terms and phrases used herein are not intended to be limiting but rather to provide an understandable description of the invention.

It is to be appreciated the embodiments of this invention as discussed below are preferably a software algorithm, program or code residing on computer useable medium having control logic for enabling execution on a machine having a computer processor. The machine typically includes memory storage configured to provide output from execution of the computer algorithm or program.

This invention may be understand in conjunction with U.S. patent application Ser. No. 13/046,405 entitled Method And Data Processing System For Financial Planning, the contents of which are hereby incorporated by reference in their entity.

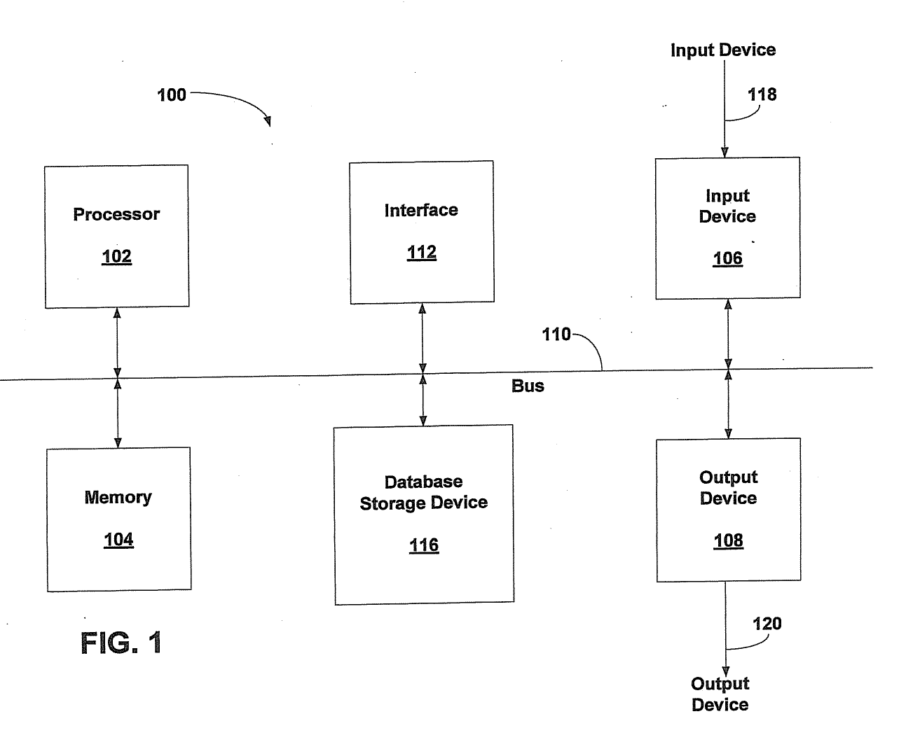

Turning now descriptively to the drawings, in which similar reference characters denote similar elements throughout the several views, FIG. 1 depicts an exemplary general-purpose computing system in which illustrated embodiments of the present invention may be implemented.

A generalized computering embodiment in which the present invention can be realized is depicted in FIG. 1 illustrating a processing system 100 which generally comprises at least one processor 102, or processing unit or plurality of processors, memory 104, at least one input device 106 and at least one output device 108, coupled together via a bus or group of buses 110. In certain embodiments, input device 106 and output device 108 could be the same device. An interface 112 can also be provided for coupling the processing system 100 to one or more peripheral devices, for example interface 112 could be a PCI card or PC card. At least one storage device 114 which houses at least one database 116 can also be provided. The memory 104 can be any form of memory device, for example, volatile or non-volatile memory, solid state storage devices, magnetic devices, etc. The processor 102 could comprise more than one distinct processing device, for example to handle different functions within the processing system 100. Input device 106 receives input data 118 and can comprise, for example, a keyboard, a pointer device such as a pen-like device or a mouse, audio receiving device for voice controlled activation such as a microphone, data receiver or antenna such as a modem or wireless data adaptor, data acquisition card, etc. Input data 118 could come from different sources, for example keyboard instructions in conjunction with data received via a network. Output device 108 produces or generates output data 120 and can comprise, for example, a display device or monitor in which case output data 120 is visual, a printer in which case output data 120 is printed, a port for example a USB port, a peripheral component adaptor, a data transmitter or antenna such as a modem or wireless network adaptor, etc. Output data 120 could be distinct and derived from different output devices, for example a visual display on a monitor in conjunction with data transmitted to a network. A user could view data output, or an interpretation of the data output, on, for example, a monitor or using a printer. The storage device 114 can be any form of data or information storage means, for example, volatile or non-volatile memory, solid state storage devices, magnetic devices, etc.

In use, the processing system 100 is adapted to allow data or information to be stored in and/or retrieved from, via wired or wireless communication means, at least one database 116. The interface 112 may allow wired and/or wireless communication between the processing unit 102 and peripheral components that may serve a specialized purpose. Preferably, the processor 102 receives instructions as input data 118 via input device 106 and can display processed results or other output to a user by utilizing output device 108. More than one input device 106 and/or output device 108 can be provided. It should be appreciated that the processing system 100 may be any form of terminal, server, specialized hardware, or the like.

It is to be appreciated that the processing system 100 may be a part of a networked communications system. Processing system 100 could connect to a network, for example the Internet or a WAN. Input data 118 and output data 120 could be communicated to other devices via the network. The transfer of information and/or data over the network can be achieved using wired communications means or wireless communications means. A server can facilitate the transfer of data between the network and one or more databases. A server and one or more databases provide an example of an information source.

Thus, the processing computing system environment 100 illustrated in FIG. 1 may operate in a networked environment using logical connections to one or more remote computers. The remote computer may be a personal computer, a server, a router, a network PC, a peer device, or other common network node, and typically includes many or all of the elements described above.

It is to be further appreciated that the logical connections depicted in FIG. 1 include a local area network (LAN) and a wide area network (WAN), but may also include other networks such as a personal area network (PAN). Such networking environments are commonplace in offices, enterprise-wide computer networks, intranets, and the Internet. For instance, when used in a LAN networking environment, the computing system environment 100 is connected to the LAN through a network interface or adapter. When used in a WAN networking environment, the computing system environment typically includes a modem or other means for establishing communications over the WAN, such as the Internet. The modem, which may be internal or external, may be connected to a system bus via a user input interface, or via another appropriate mechanism. In a networked environment, program modules depicted relative to the computing system environment 100, or portions thereof, may be stored in a remote memory storage device. It is to be appreciated that the illustrated network connections of FIG. 1 are exemplary and other means of establishing a communications link between multiple computers may be used.

FIG. 1 is intended to provide a brief, general description of an illustrative and/or suitable exemplary environment in which embodiments of the below described present invention may be implemented. FIG. 1 is an example of a suitable environment and is not intended to suggest any limitation as to the structure, scope of use, or functionality of an embodiment of the present invention. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

In the description that follows, certain embodiments may be described with reference to acts and symbolic representations of operations that are performed by one or more computing devices, such as the computing system environment 100 of FIG. 1. As such, it will be understood that such acts and operations, which are at times referred to as being computer-executed, include the manipulation by the processor of the computer of electrical signals representing data in a structured form. This manipulation transforms the data or maintains them at locations in the memory system of the computer, which reconfigures or otherwise alters the operation of the computer in a manner understood by those skilled in the art. The data structures in which data is maintained are physical locations of the memory that have particular properties defined by the format of the data. However, while an embodiment is being described in the foregoing context, it is not meant to be limiting as those of skill in the art will appreciate that the acts and operations described hereinafter may also be implemented in hardware.

Embodiments may be implemented with numerous other general-purpose or special-purpose computing devices and computing system environments or configurations. Examples of well-known computing systems, environments, and configurations that may be suitable for use with an embodiment include, but are not limited to, personal computers, handheld or laptop devices, personal digital assistants, multiprocessor systems, microprocessor-based systems, set top boxes, programmable consumer electronics, network, minicomputers, server computers, game server computers, web server computers, mainframe computers, and distributed computing environments that include any of the above systems or devices.

Embodiments may be described in a general context of computer-executable instructions, such as program modules, being executed by a computer. Generally, program modules include routines, programs, objects, components, data structures, etc., that perform particular tasks or implement particular abstract data types. An embodiment may also be practiced in a distributed computing environment where tasks are performed by remote processing devices that are linked through a communications network. In a distributed computing environment, program modules may be located in both local and remote computer storage media including memory storage devices.

With the exemplary computing system environment 100 of FIG. 1 being generally shown and discussed above, a method of operation of the present invention utilizing system 100 will now be described.

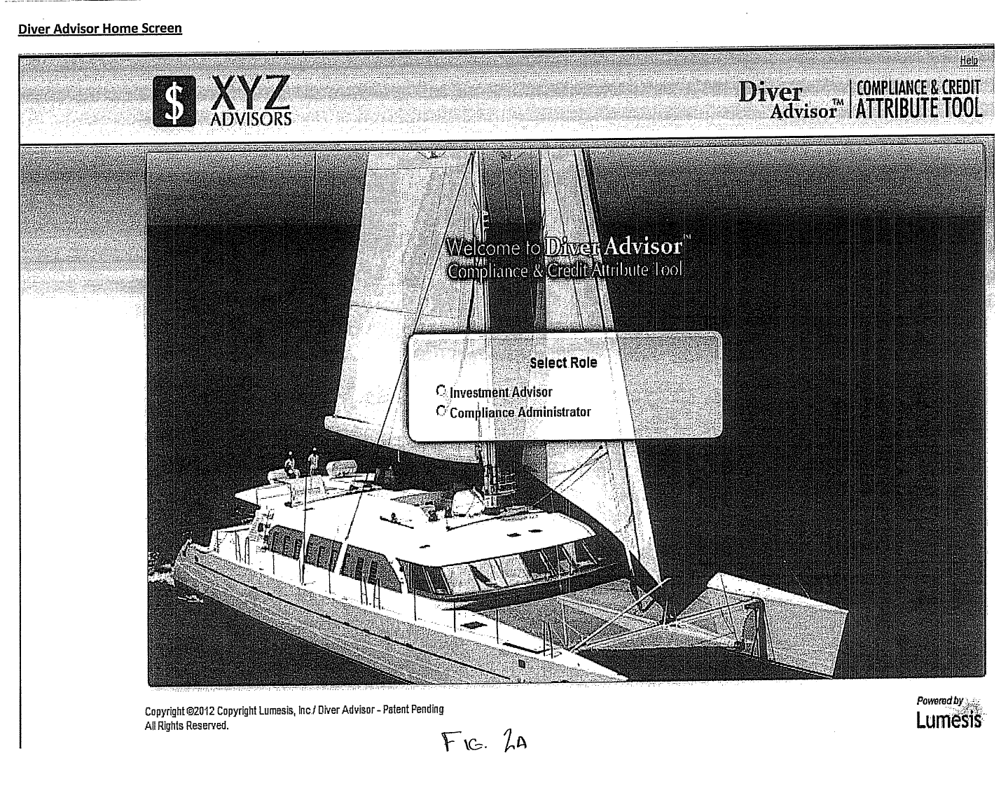

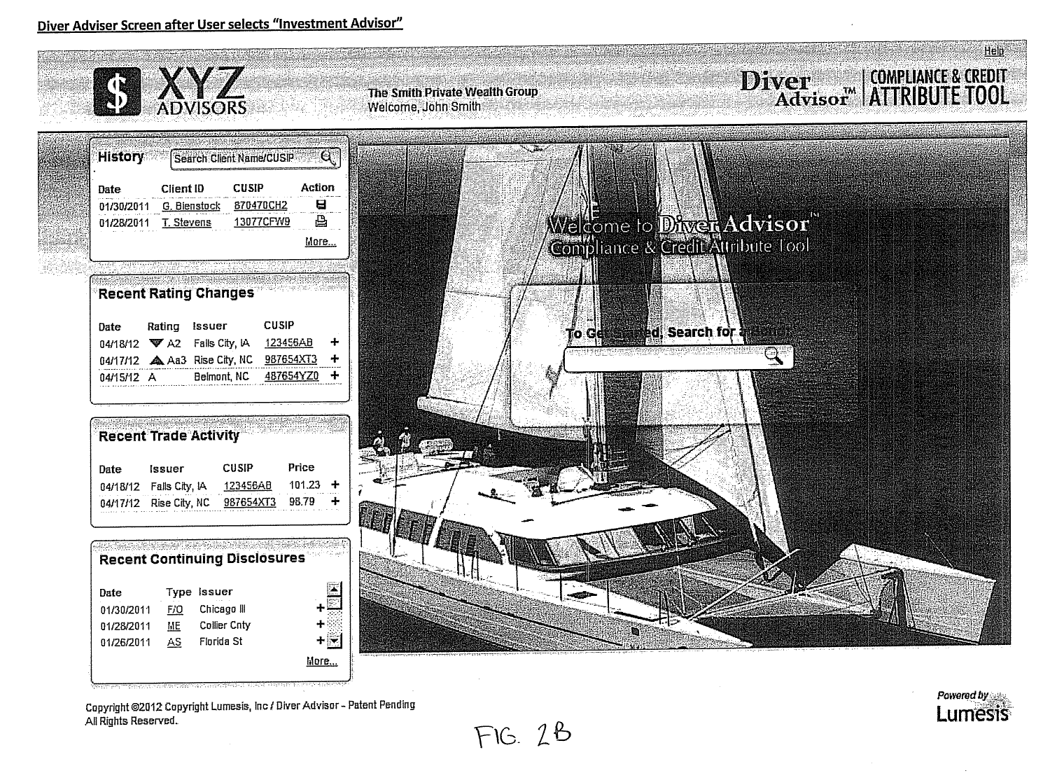

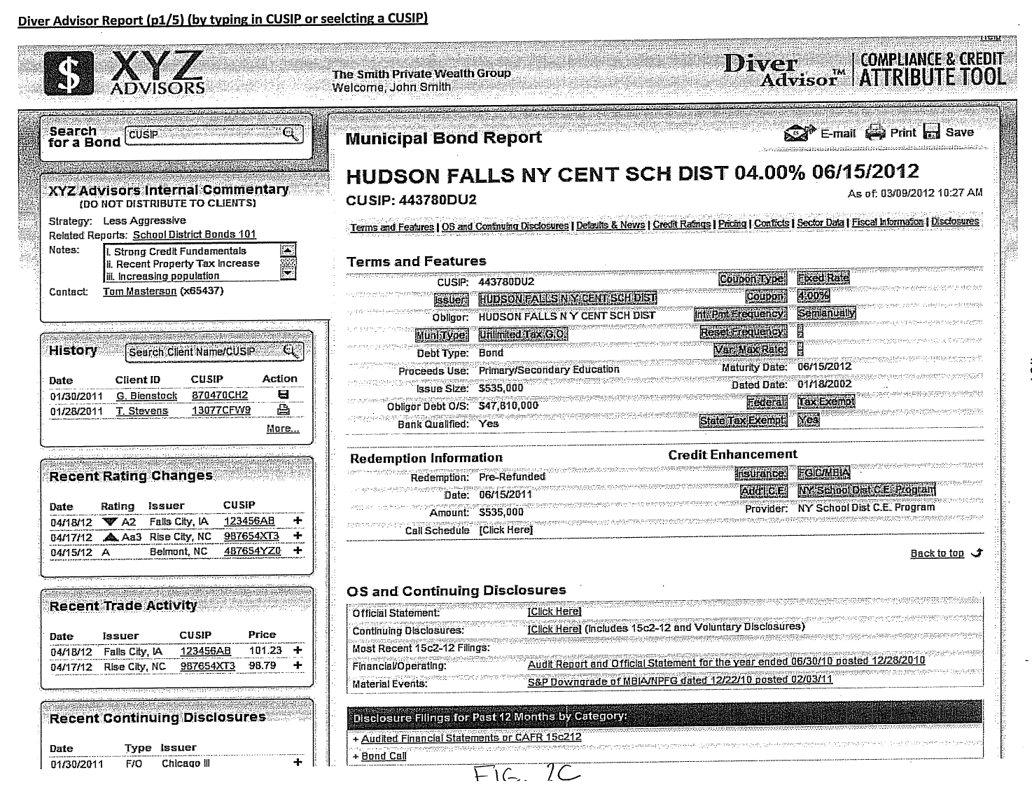

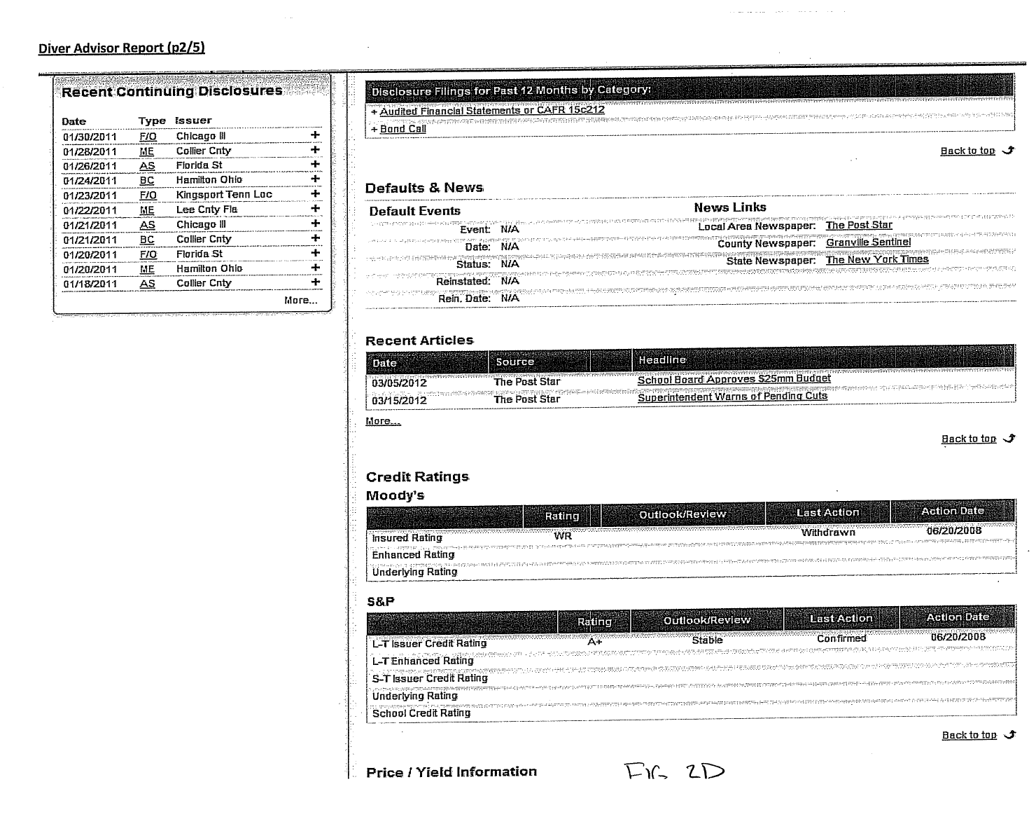

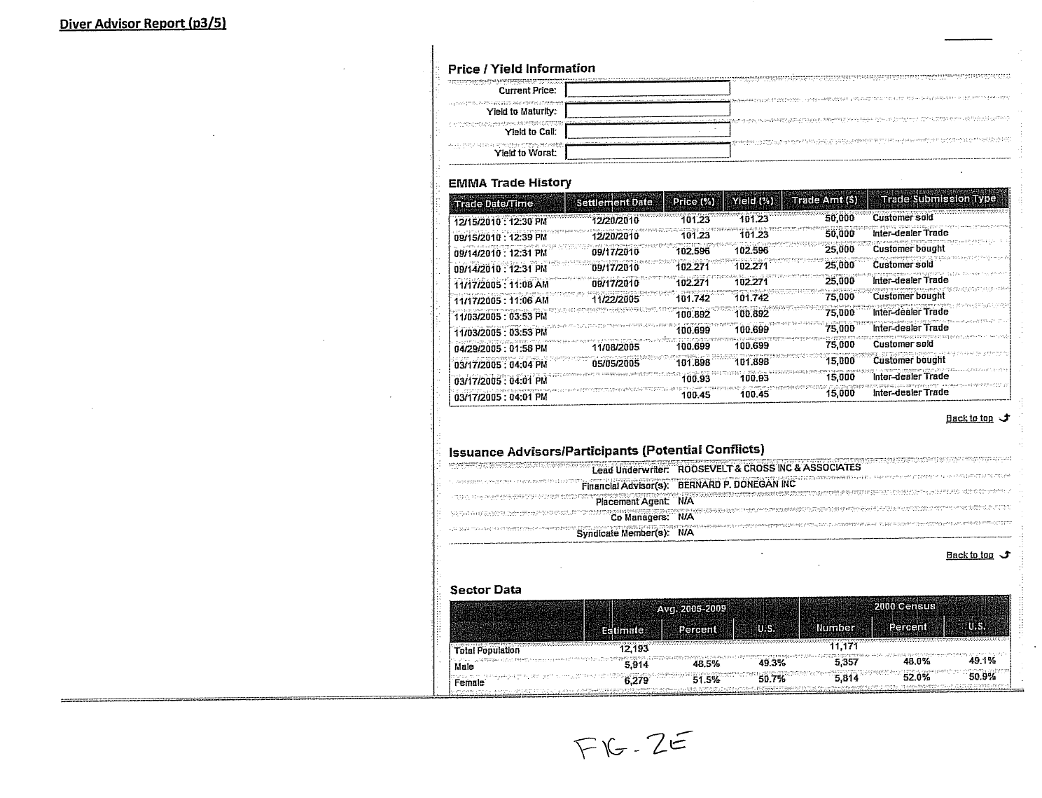

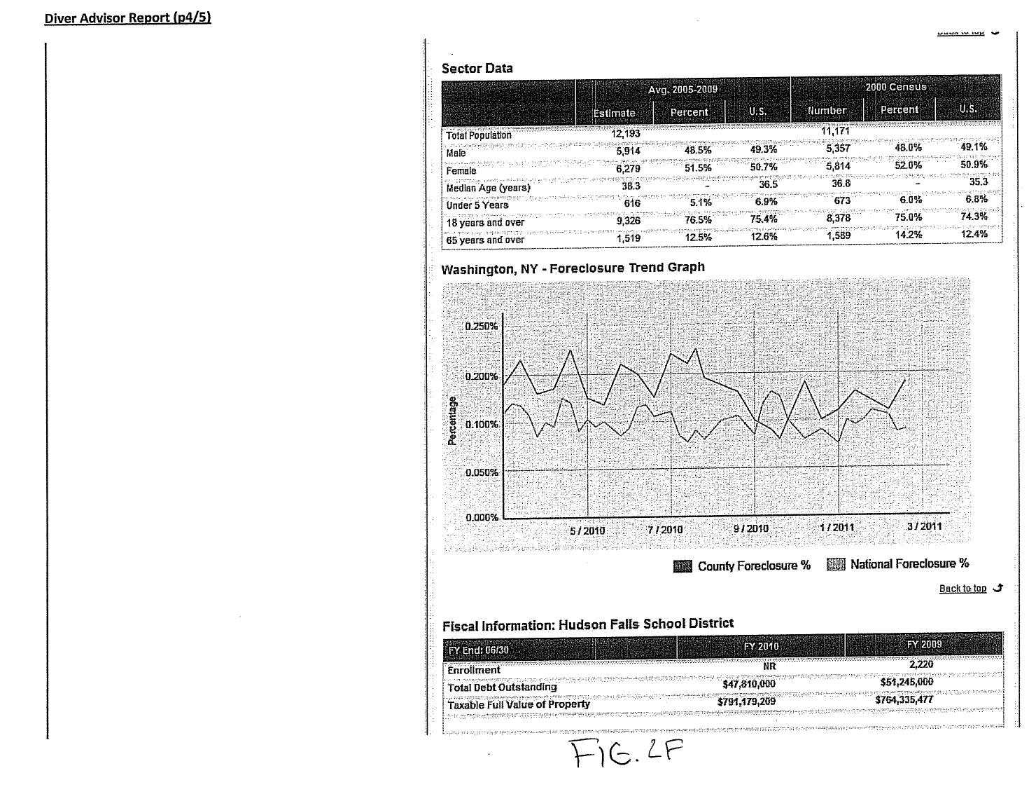

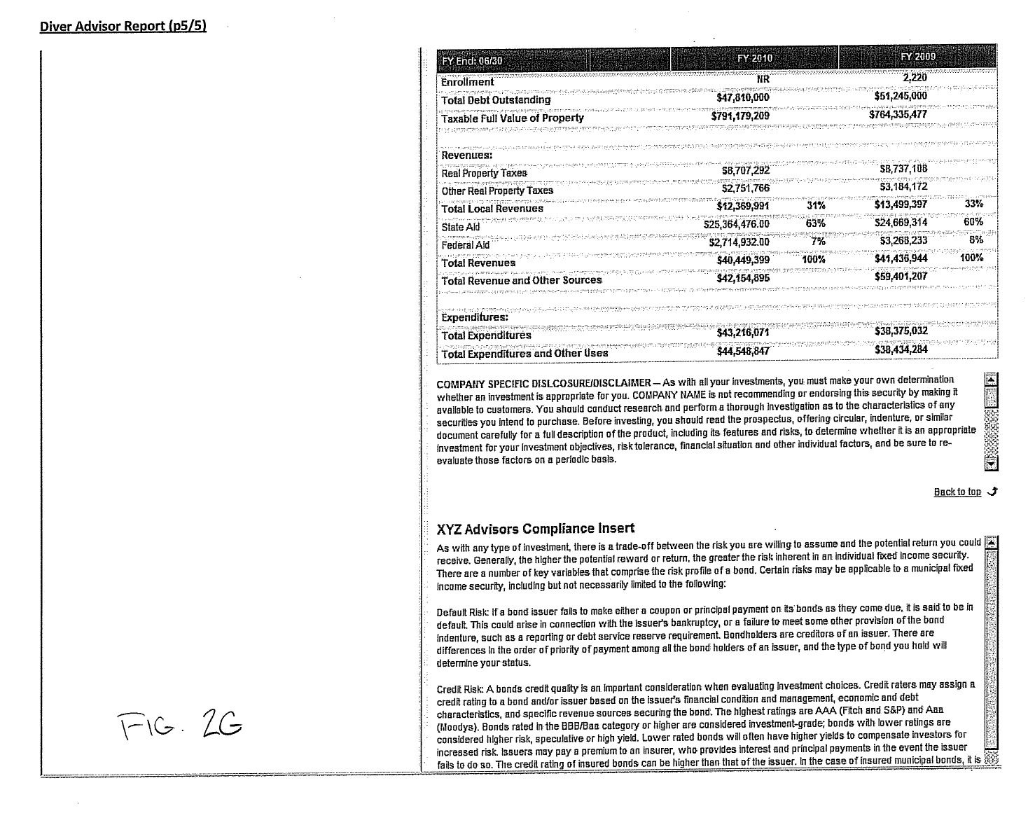

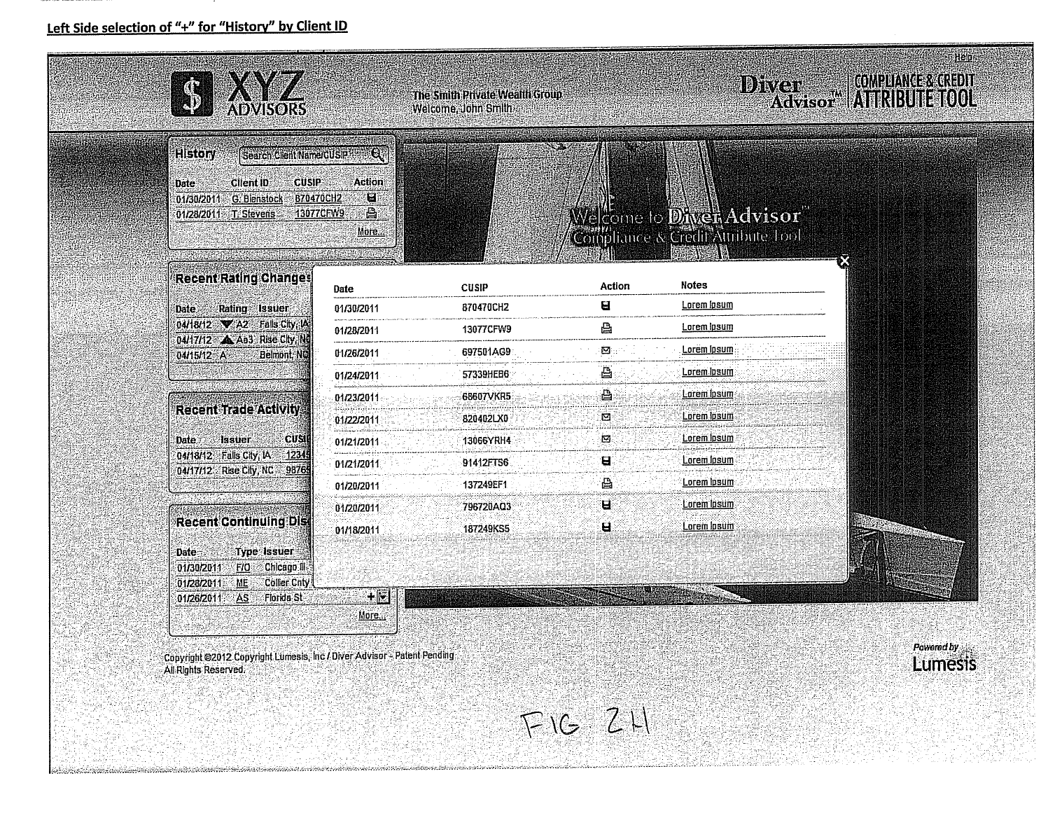

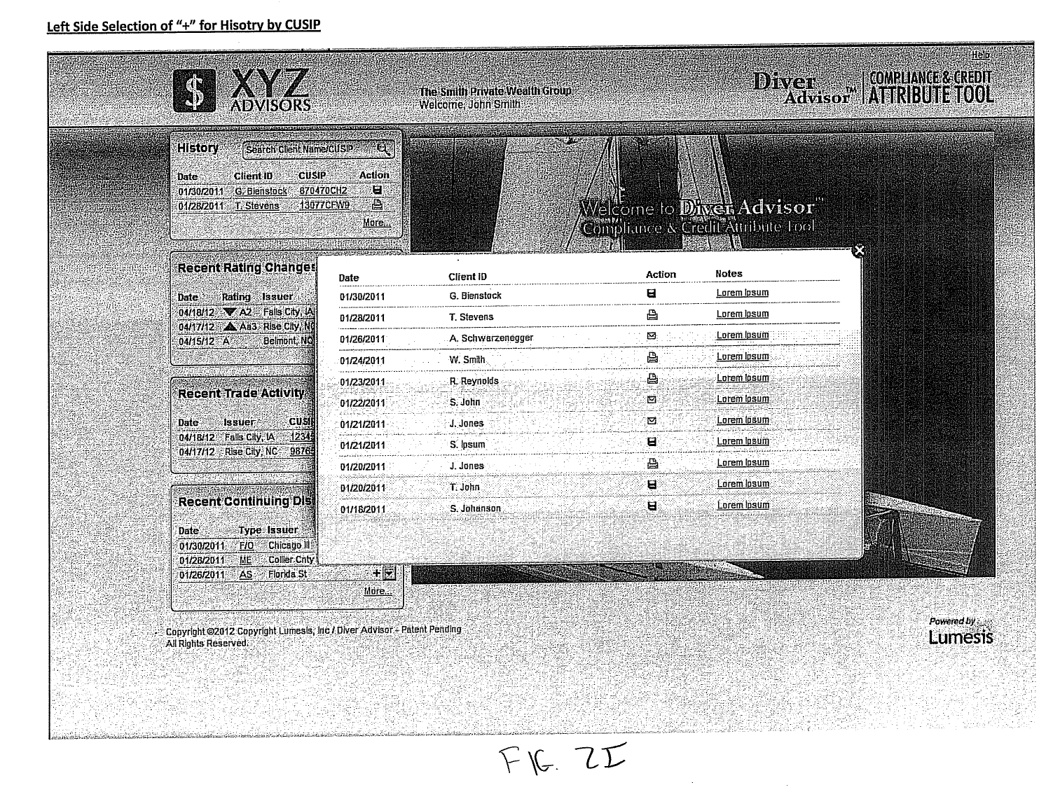

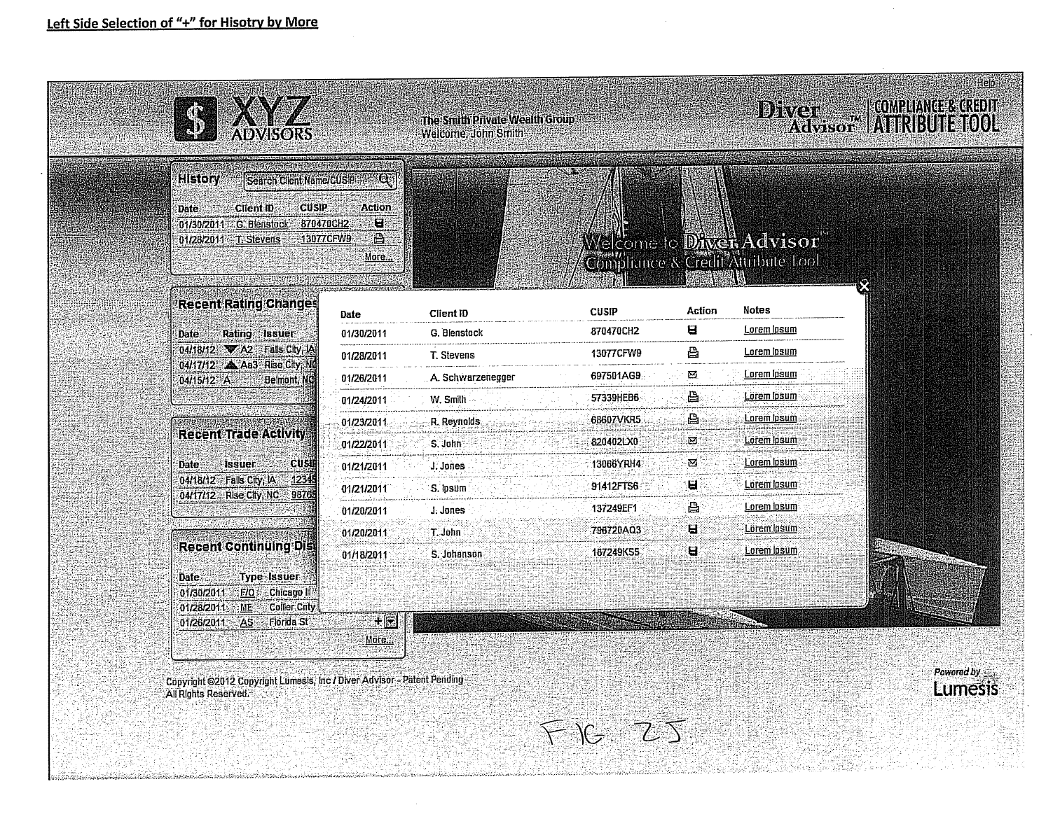

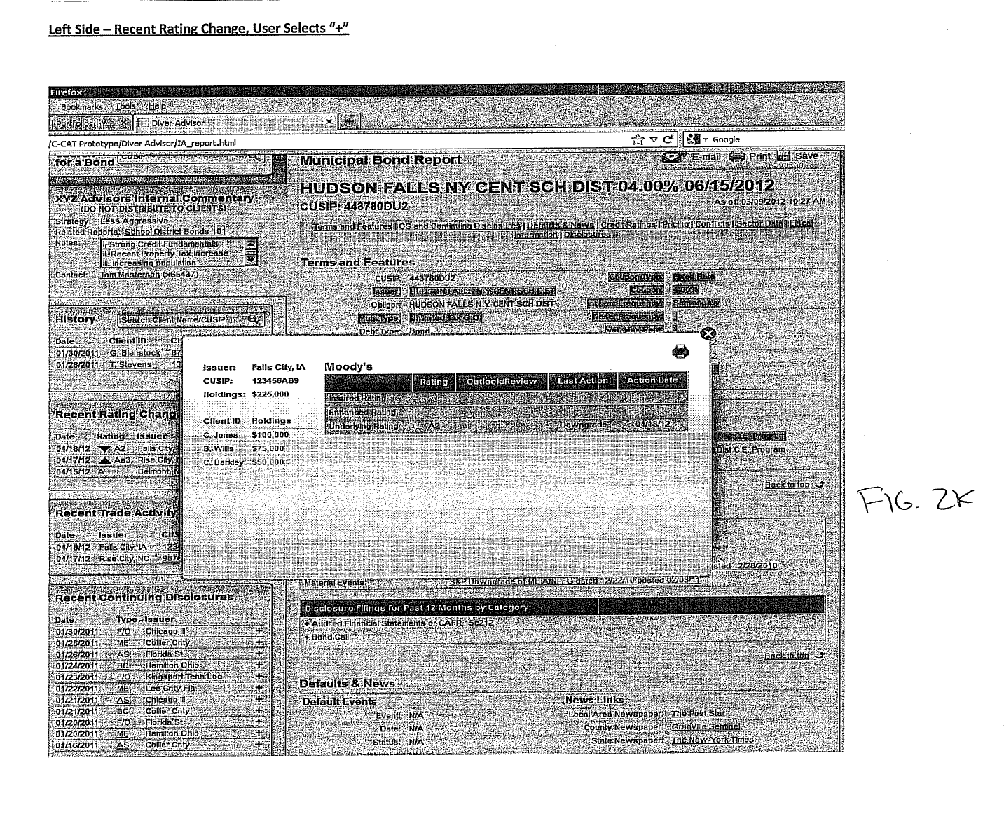

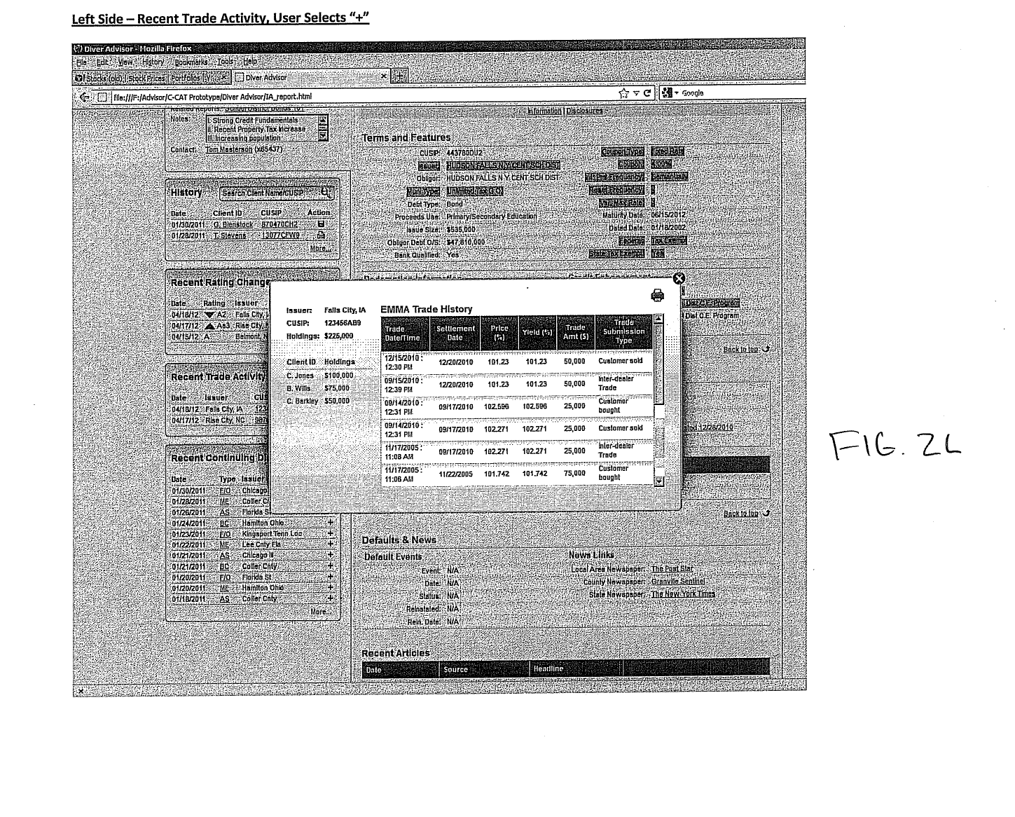

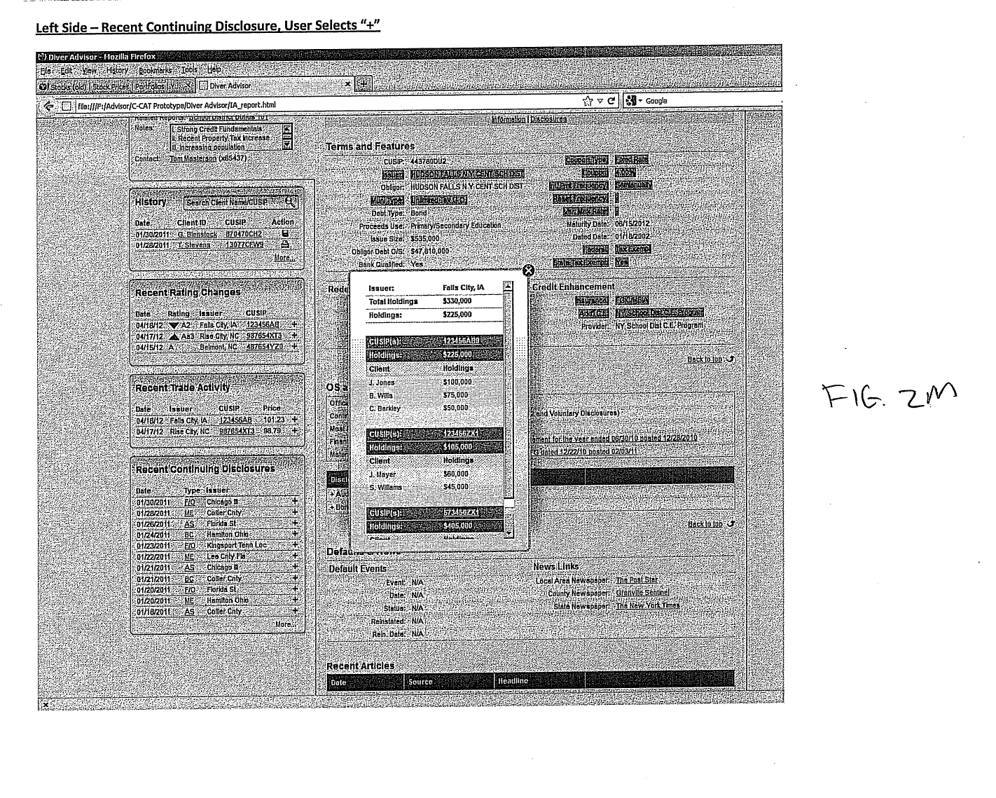

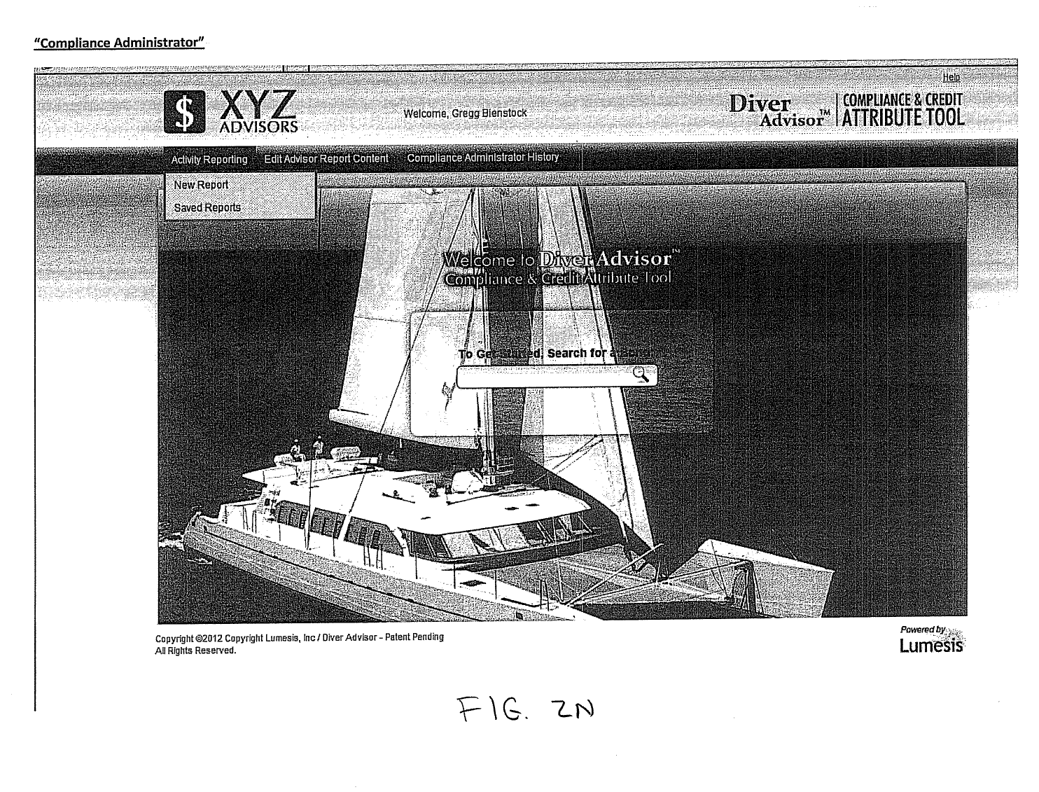

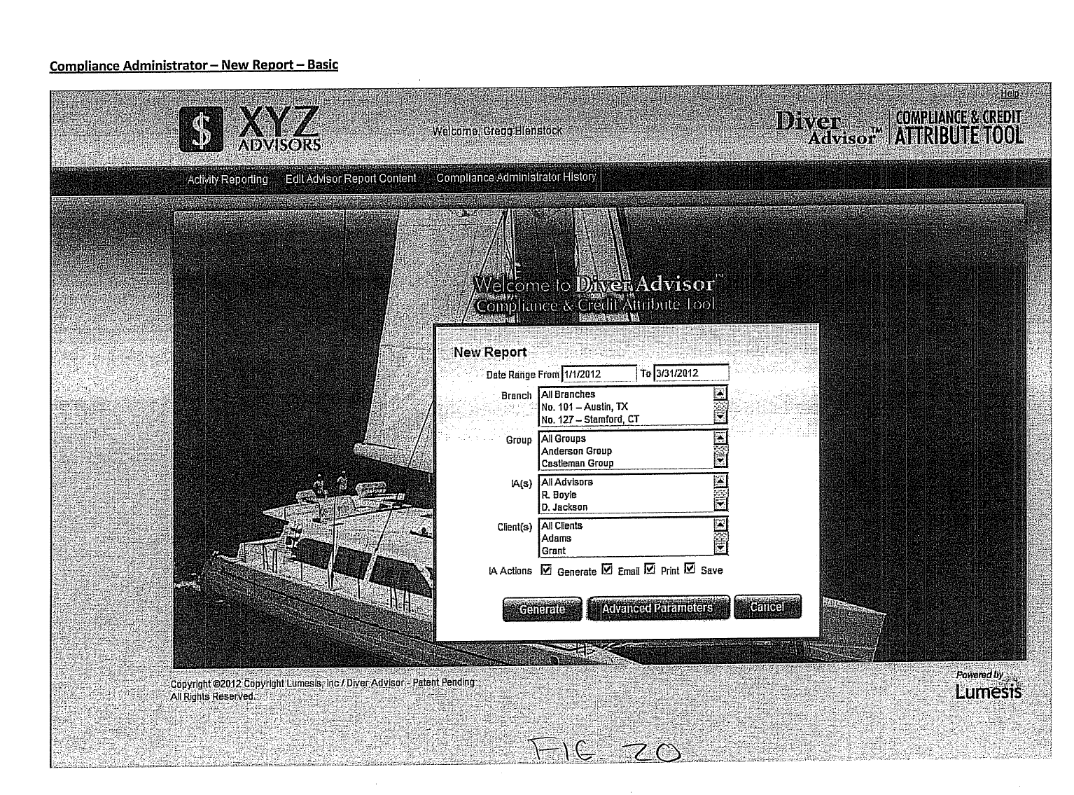

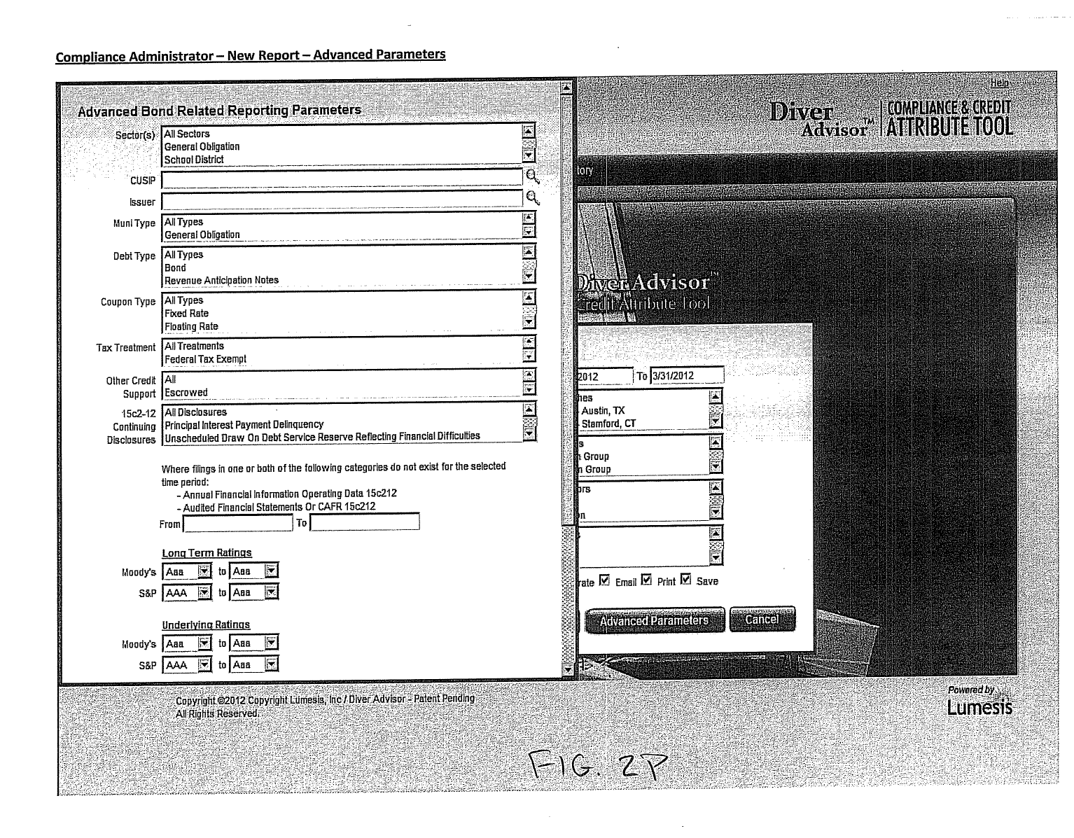

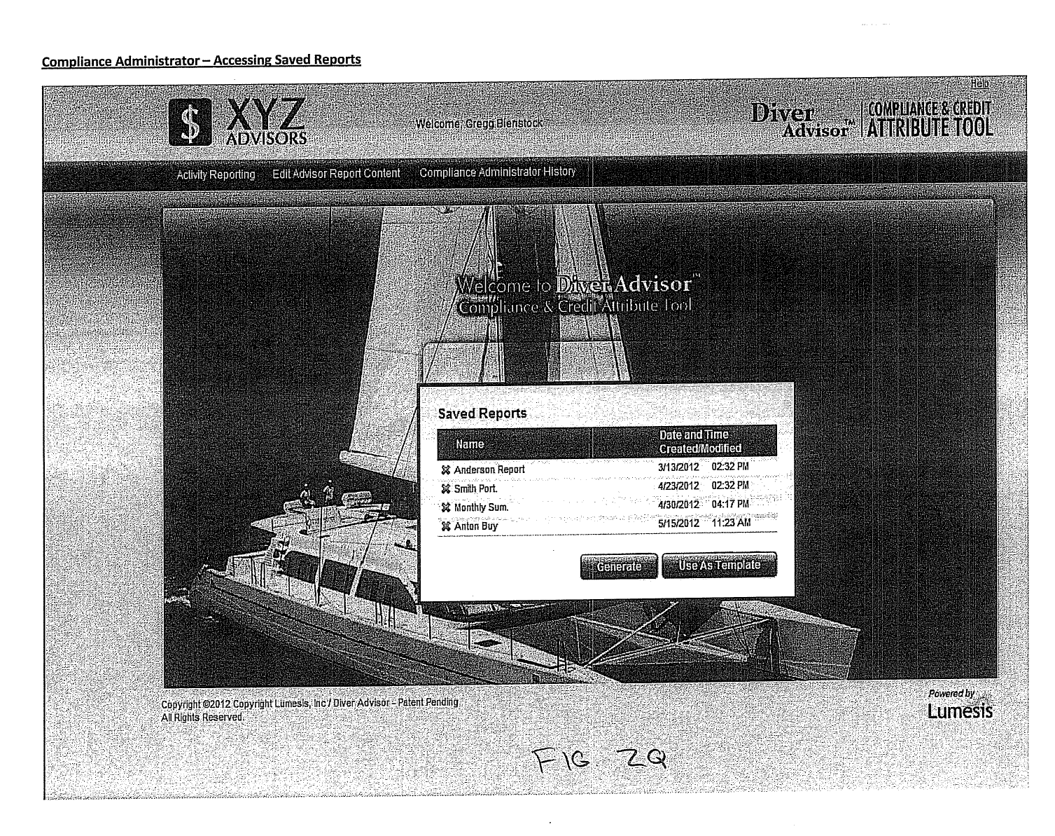

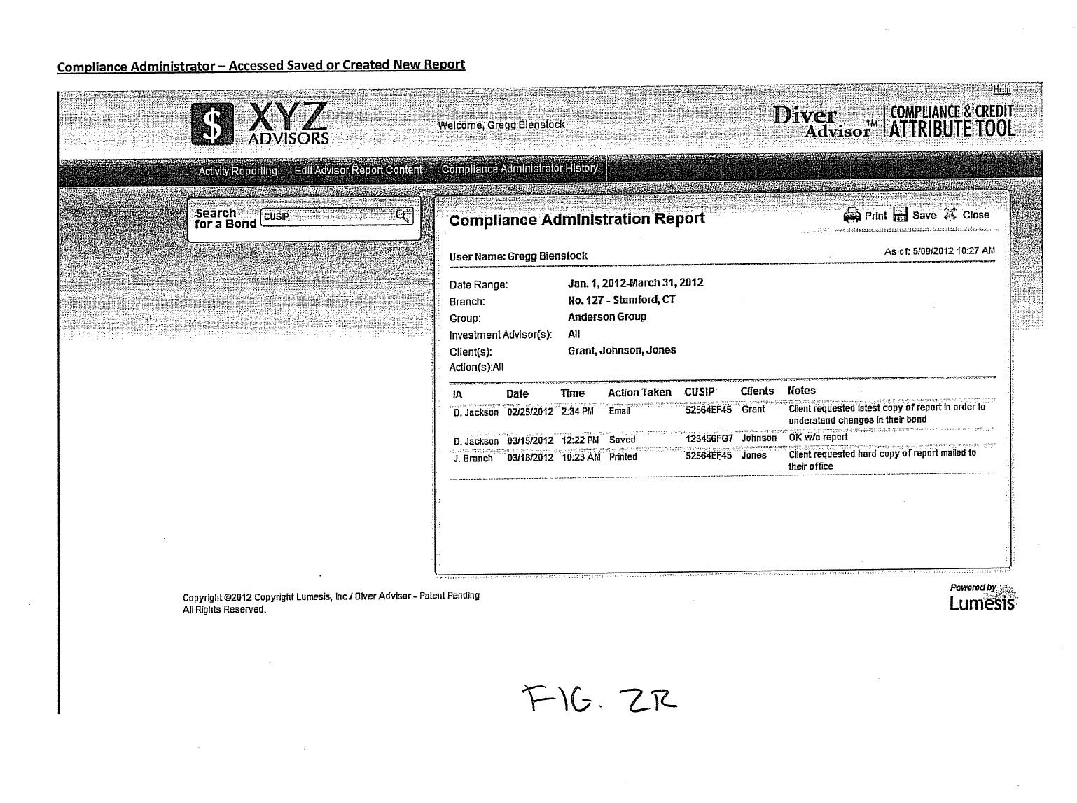

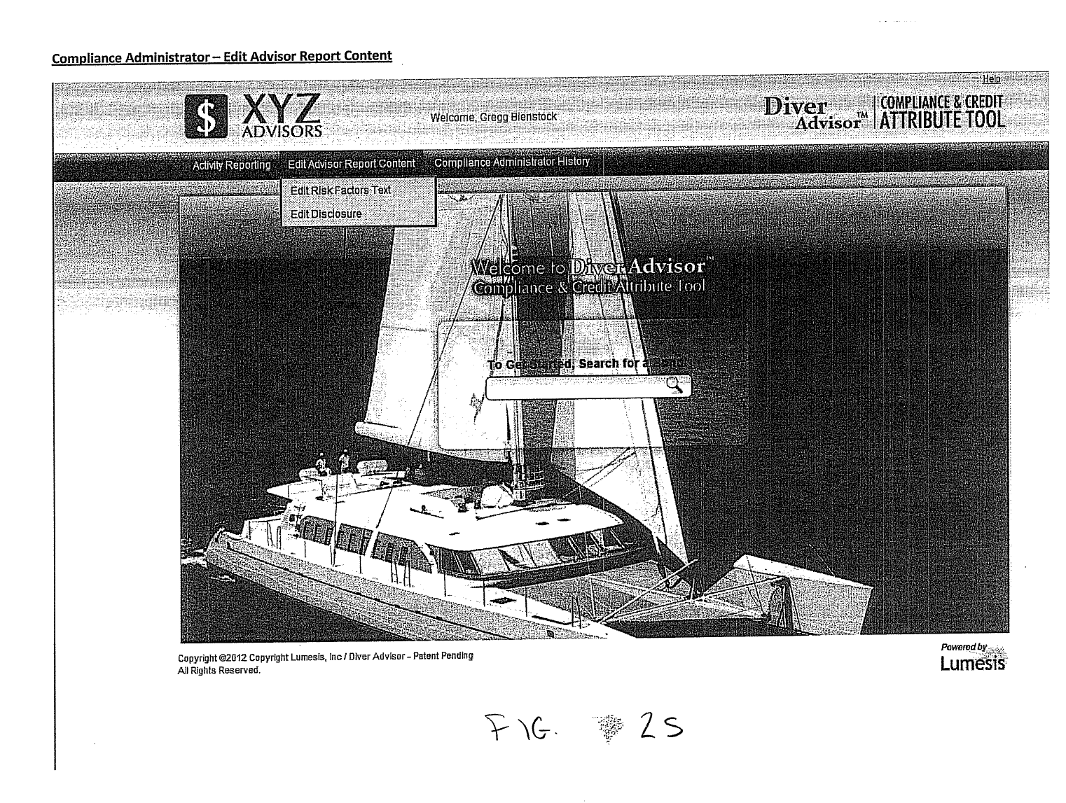

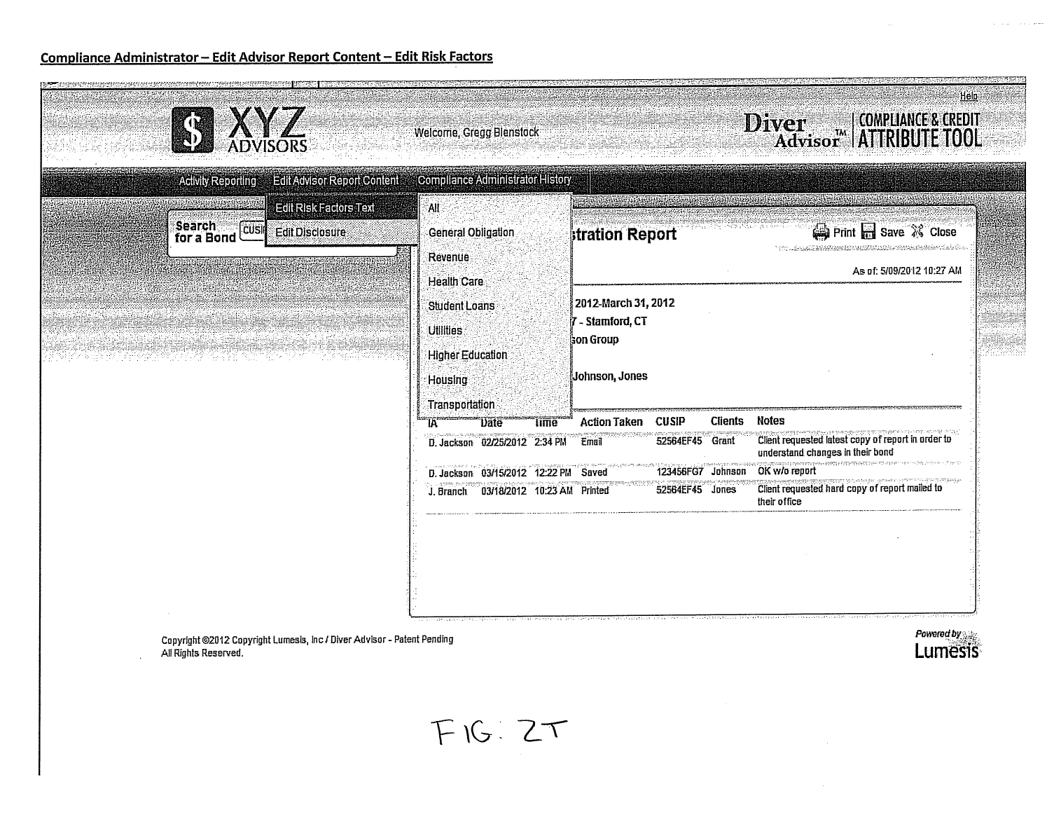

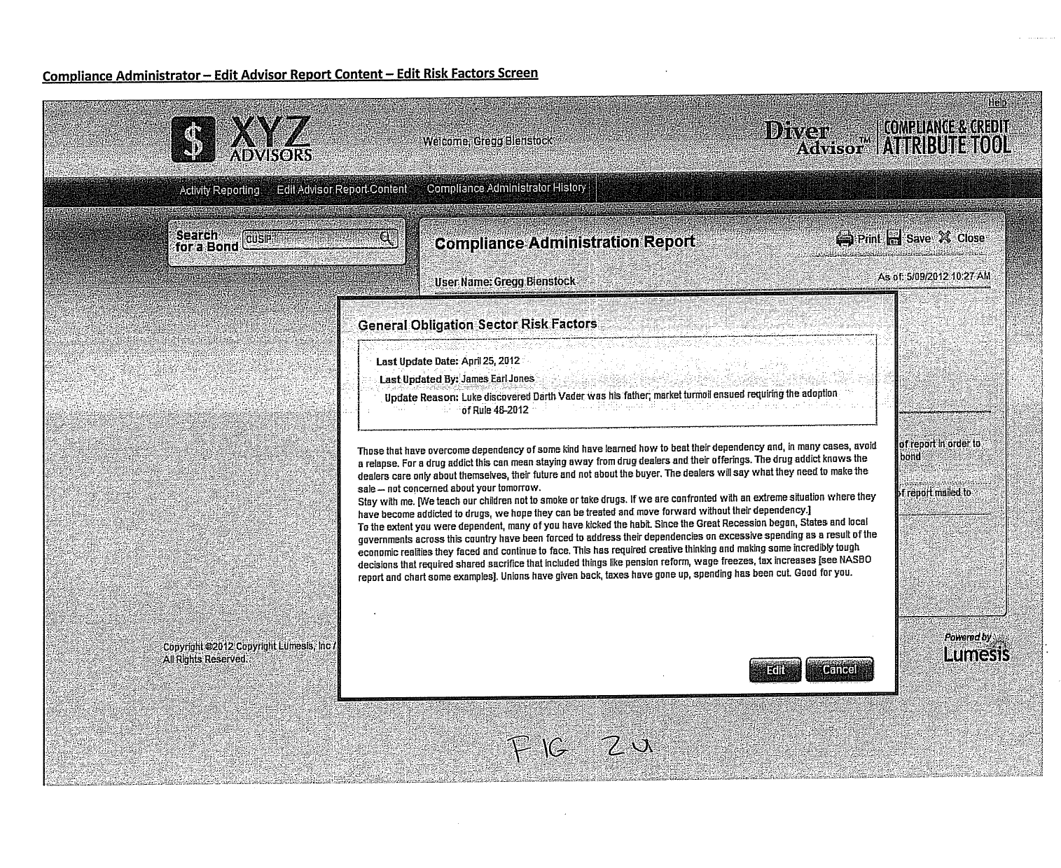

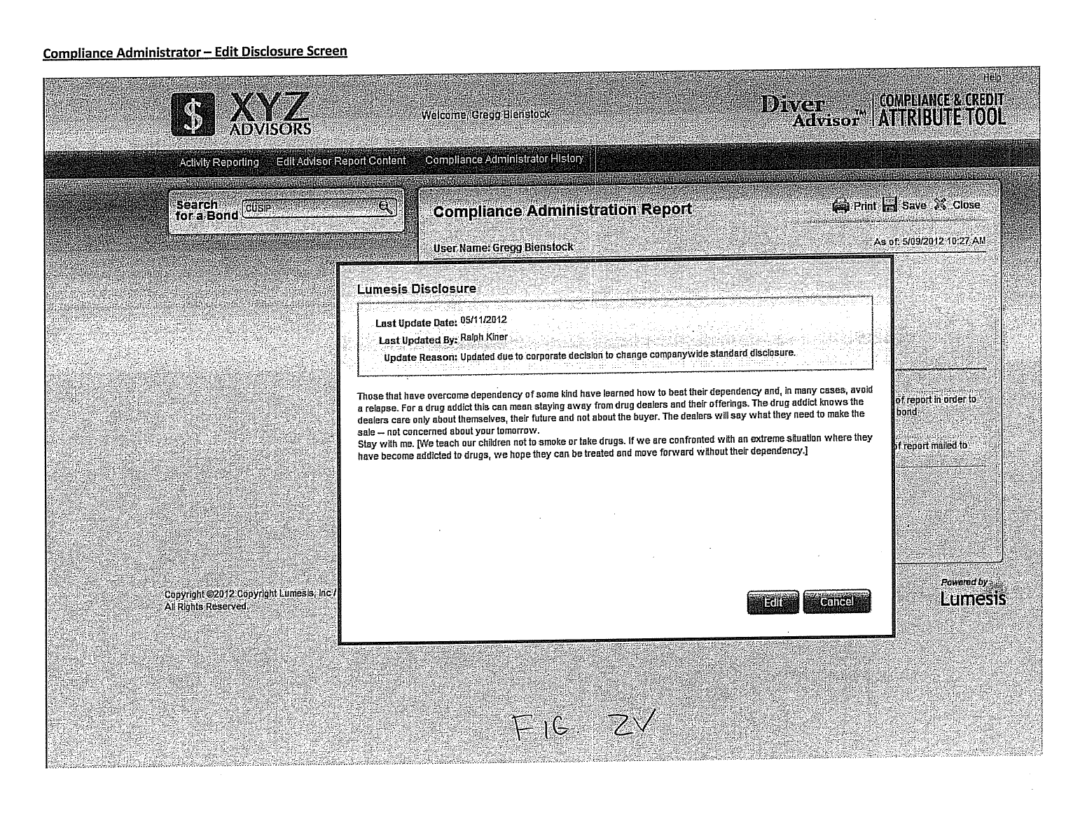

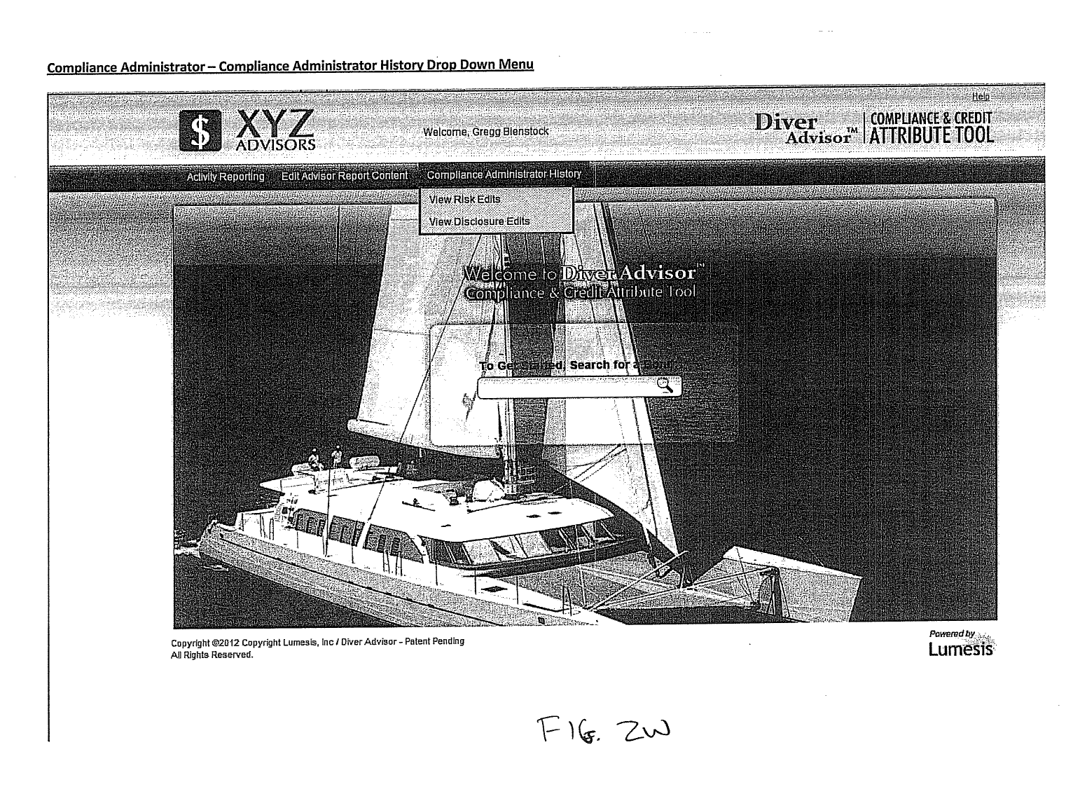

First, it is to be understood and appreciated that the present invention relates to a system and method which provides a compliance and credit attribute tool, preferably, but not limited to, municipal markets using system 100, or components thereof. The present invention is operative and configured to provide organizations and users information to preferably meet their compliance related obligations, provide a means for dissemination of credit information prepared by the institution and provide their clients with information enabling such clients to make enhanced educated and informed decisions making trades. With reference to FIGS. 2A-2W, illustrated are exemplary reports and screen shots providing component aspects and a complete rendition of the aforesaid generated reports. Preferably, the present invention is a combination of compliance features, individual bond attribute information, economic and demographic data on preferably a micro basis (e.g., State, county, city, school district and other sub-county geographic areas), geo-location level, fiscal/financial information, and custom risk and credit notices as illustrated in FIGS. 2A-2W.

It is to be understood and appreciated the present invention is generally a compliance and research system configured and operative to generate detailed reports for a financial asset, such as a CUSIP, as shown in FIGS. 2A-2W. Further it is to be understood and appreciated it is configured and operative to enable a subscribing institution to modify data and information displayed to the Users within that Company and displayed to their constituents (e.g., providing turn-on or turn-off features of the report). Additionally, the present invention is configured and operative to maintain detailed historical record/logs of User activity, and include the generation of on-screen and printable reports that are time and date stamped and provide for the saving of the on-screen report (e.g., FIGS. 2C-2G) as an electronic file that can be stored locally by the client and/or e-mailed to clients.

In use, the user access to the present invention is preferably gained through a website whereafter the user logs on to the site via user name and password. It is it to be appreciated the present invention is also configured and operative to permit flexibility of single sign-on by active directory whereby a user is auto logged on when they log into their work PCs and IT dept controls who has access.

The functionality of the present invention will now be discussed below. Starting with when a user generates a report on-screen, the report is preferably date and time stamped (e.g., FIGS. 2C-2G) and the system preferably adds the Report Generation to a historical log of actions, which may include a client side database server as dictated by client needs. The present invention then accesses the information set forth in FIGS. 2C-2G, for instance. It is to be appreciated and understood certain fields of FIGS. 2C-2G may require calculation, combining of data, list creation or link creation, preferably performed by system 100, such as:
Obligor debt O/S;
Official Statement link from EMMA;
Import of lists of disclosures, type and link from EMMA; and
Identification of most recent Financial/Operating filing from EMMA;
Identification of Material Events filings from EMMA; and
Links to local, county and State news sources covering the geography associated with the CUSIP and news stories associated with the geography and sector of the CUSIP.

Additionally, it is to be understood and appreciated that Credit Ratings are preferably obtained via a pass through from appropriate and relevant agencies on a permission basis. Also, other sources/news may be obtained via:
Issuer website from EMMA; and
Links to Local Newspaper from a relational database of geo-location and newspaper and link.

With reference to the generated report depicted in FIG. 2C, the left hand side preferably consists of information specific to each User and is preferably available to the User. The Company-specific “Internal Commentary” box preferably contains information and reports entered by the Credit Administrator (as explained further below) being applicable to the specific CUSIP report generated by the User. The “Internal Commentary” box may include company-specific notes, ratings or designations and links to reports or related sites. The “History” box provides the User a listing of their recent history using the system and will dates, client identification, CUSIP and action. The User may access all recent activity for a given client by selecting the client identification and can access the report by selecting the CUSIP.

With continuing reference to FIG. 2C, the “Recent Ratings Changes” box preferably provides the User information with regard to ratings changes for positions in their client portfolios. The information provided included the date, ratings change, issuer identification and associated CUSIPs. The User can expand the information by selecting the “+” sign and access the ratings activity, client holdings by account and total amount of all clients for the affected CUSIP. With regards to the “Recent Trade Activity” box, it provides the User a list of recent trades of positions held in their clients' portfolios. The information provided may include date, issuer, CUSIP and price and provide the User the ability to select the “+” next to a price information to access all client's holding the CUSIP, trade date and time, Settlement Date, Price, Yield, Trade Amount and Trade Submission Type.

Further features of the report generated by system 100 may include:
Links in the generated report are preferably marked such that the User knows that the link exists and must be clicked to retrieve the document/information. Links to documents or third party sites are preferably live upon transmission of the report by email to a user's client.
“Key Economic and Demographic Drivers” and “Fiscal/Financial Information” sections may vary by sector and sub-sector designations.
Once a report is generated, the User has preferably three options they can click on (can click more than 1):
   1. Save;
   2. Email; and
   3. Print.
Each one of the three options listed above constitutes an Action which is preferably stored in the historical log and is date and time stamped.
Save—When the User clicks on this button:
   1. A window preferably appears requesting the User to enter an investor account number or investor name (each company will have their own preference).
   2. A text box is provided labeled “Internal Notes” which is configured and operative to allow the User to type in free text. The text from the Notes box is preferably stored as a section at the end of the report in the file.
   3. Cancel and Save buttons appear below the Notes text box.
      If the User clicks on Save, the file is stored, complete with all links, in a client designated file directory using a unique file name of, such as: [CUSIP_INVESTOR ID_DATE STAMP_TIME STAMP].
      The present invention system preferably adds the Save to the log of Actions along with what was input to the Investor ID field, the date and time stamp.
      Once the file is saved or if the User clicks Cancel, the User is enabled to return to the original report.
      The User may click this same button again to save it after reviewing with another investor and the process repeats.
Email—When the User clicks on this button,
   1. A window preferably appears requesting the User to enter an investor account number or investor name (each company will have their own preference).
   2. A text box is provided labeled “Internal Notes” which configured and operative to allow the User to type in free text. The text from the Notes box is preferably stored in the system but not available for view by the User's client.
   3. Cancel and Send buttons appear at the bottom of this screen.
      If the User selects the Send button, the present invention system preferably automatically opens an e-mail shell and populates the shell with a file of a PDF of the report. The system adds the Send to Investor to the log of Actions with the date and time stamp.
      Once the file is sent or if the User clicks Cancel, the User goes back to the original report.
      The User can click this same button again to send it to another investor and the process repeats.
Print and Mail—When the User clicks on this button:
   1. A window preferably appears requesting the User to enter an investor account number or investor name (each company will have their own preference).
   2. A text box is provided labeled “Internal Notes” which configured and operative to allow the User to type in free text. The text from the Notes box is preferably stored in the system but not available for view by the User's client.
   3. Below the Internal Notes, the User can select or de-select the printing of the Report, Official Statement and/or Latest Financials.
   4. A Print and Cancel button may appear below the Investor ID field.
   5. If the User clicks on Print, the User is provided a choice of printers connected to User's computer to print the report. The print-out preferably includes two additional pages—1) a listing of documents that the User must also print out and send to the investor; and 2) a listing of the URLs for all of the links in the document and a note to the investor that in order to access the items referenced in the report as links, they must enter the URLs into their web browser for retrieval.
   6. The present invention preferably adds the Print and Mail to the log of Actions along with what was input to the Investor ID field, the date and time stamp.
   7. Once the report is printed or if the User clicks Cancel, the User preferably goes back to the original report.
   8. The User can click this same button again to print it for another investor and the process repeats.

Features of the Sectors and Sub-Sectors of the generated report (FIGS. 2A-2W) of the present invention will now be discussed below:
6 digit CUSIPs are preferably mapped to a Sector and potentially a Sub-Sector (“Sector Designations”).
One Sector may have zero to a plurality of Sub-Sectors.
Each Sub-Sector preferably has one Sector relationship.
The Sectors and Sub-Sectors are preferably based on a relationship mapping from different Data Fields.
“Key Economic and Demographic Drivers” and “Fiscal/Financial Information” sections preferably vary by Sector and Sub-Sector designations (wherein data sets for all CUSIP's mapped to a particular Sector/Sub-Sector combination will be preferably controlled by the “Credit Admin”, as described further below).
Data Sets for all CUSIPs mapped to a particular Sector/Sub-Sector combination will be controlled by the “Credit Admin” as described below.
Table I below indicates the Sectors/Sub-Sectors and their relationships to the Data Fields:

TABLE I

| | | MDF: | MDF: |
|---|---|---|---|
| Sector | Sub-Sector | security_code_i | use_of_proceeds_c |
| General | | | |
| Obligation | | | |
| | School | | |
| | District | | |
| Tax Backed | | | |
| Higher | | | |
| Education | | | |
| Utilities | | | |
| Healthcare | | | |
| Housing | | | |
| Transportation | | | |

It is further to be appreciated and understood another unique feature of the present invention is it is configured and operative to provide data on a more granular, localized level, in addition to State and county data. Thus, the present invention increases the number of Location Types and mapping 6-digit CUSIPs to these new Locations. Additionally, new Core Data Sets will be tagged/designated to these new Location Types. Table II below indicates the various Location Types and an associated unique identifier:

TABLE II

| Location | Unique Identifier |
|---|---|
| USA | FIPS = 00 or 00000 |
| State, DC or US Territory | Two Digit FIPS |
| County | Five Digit FIPS |
| City/Town | |
| School District | |
| MSA | |
| Utility District | |
| Hospital Service Area | |

Discussed herein below are the hierarchical relationships between the locations:
1 USA
   a. State, DC or US Territory
      i. County
         1. City/Town
      ii. School Districts
   b. MSA
   c. Utility District
   d. Hospital Service Area

With regards to system administration of the present invention, preferably there are four Administrator Roles on Client side:
Compliance Administrator—Controls compliance content to Users and has the ability to report on all User activity;
Credit Administrator—Controls economic/demographic and financial/fiscal content to Users; enters and makes available relevant credit notes and reports; accesses trade and report activity of Users to direct future research;
User Administrator—Controls the management of Users—additions, deletions, modifications;
Super Administrator—designate Administrators;
Can be more than one of each Administrator in a single Company; and
One User may serve one or more Administrator roles.

In regards to a Compliance Administrator (see for example FIGS. 2N-2W), the present invention is preferably configured and operative such that:
The Compliance Administrator has access to a screen that will permit them to either “check” or “un-check” all data fields in the present invention designated as Compliance Data Fields (CDFs);
Any CDFs that are “checked” by the Compliance Administrator preferably appear on reports that generate for the User (Investment Advisor, Financial Advisor, Private Wealth Manager and the like); Any CDFs that are “unchecked” by the Compliance Administrator preferably do not appear on the reports that generate for the User (Investment Advisor, Financial Advisor, Private Wealth Manager and the like);
When the Compliance Administrator changes the status of CDFs, the Compliance Administrator preferably submits changes by clicking a “Submit” button.
Upon clicking “Yes” to commit changes, a log entry is preferably created showing the date, time and changes made by the Compliance Administrator. This log is also preferably available to the Compliance Administrator (current and future), the Credit Administrator and the Super Administrator.
At least one of the CDF's may preferably include a free-text area in the Company “Specific Disclosures” section of the report. The Compliance Administrator will be able to “check” or “un-check” this feature and have the ability to modify the existing text.
Preferably another CDF which may have a free-text area is the “Company Specific Disclosure/Disclaimer” area of the report. The Compliance Administrator has the ability to modify the existing text or copy and paste the text that they want into the text box provided. Additionally, the present invention preferably maintains an historical log of all modifications to the status of CDFs—time and date stamps as well as the Username making the change. Any Compliance, Credit and Super Administrator will be able to query and generate a report of Compliance Administrator actions.
Compliance Administrator is preferably able to query for Users by Name or by one or both of the client defined User subcategories (these may include number (if company-designated ID), department, group, team) and pull up a historical log of report generation, as well as print a report of the same wherein the log preferably includes at least User Name and a historical chronological listing of Actions (defined above). Additionally, the Compliance Administrator is able to search by Action type and to search for Actions by 9 digit CUSIP for one User, one of the two client defined User subcategories, or for the entire Company. In addition, the Compliance Administrator can search or report on any data point maintained and tracked in the system and can report on the same for any User, group of users, location, divisions, department, group, company and the like.

In regards to a Credit Administrator, the present invention is preferably configured and operative such that the Credit Administrator:
has access to a panel that identifies all sectors, sub-sectors and all data sets available for assignment to any given sector;
selecting any sector or sub-sector assigns and/or reveals those data sets that are active including the Locations for which the data sets exist (i.e. State, County, City, etc).
Either by click or drop and drag, the Credit Administrator has access to a listing of available data sets whereby the Credit Administrator is able to activate/deactivate any data set for any sector or subsector.
The present invention is configured and operative such that upon the Credit Administrator clicking “Yes” to commit changes, a log entry is created showing the date, time and changes made by the Credit Administrator. This log may be available to the Compliance Administrator, the Credit Administrator and Super Administrator.
The present invention is configured to allow the Credit Administrator to enter credit notes and information and attach reports by geography, issuer, obligor, CUSIP or other identifying factor and, upon entry of the same, be available to all Users for their review (but not for dissemination to the User's clients). The Credit Administrator can set a reminder or notes expiration feature so that outdated notes, as defined by the Credit Administrator, are flagged to the Credit Administrator for update and no longer available to the Users.
The present invention is configured to allow the Credit Administrator to generate reports identifying most frequently traded trades and/or most frequently generated reports by either geography, issuer, obligor, sector, CUSIP or any other identifying factor captured and tracked within the system.

In regards to a User Administrator, the present invention is preferably configured and operative such that a User Administrator may easily add/remove users/locations/departments/groups/offices via alphabetical listing/sorting, user list and email import, etc. It is to be understood and appreciated that there will be as many user subcategories as required per institution that the User Administrator can create and allocate Users to (e.g., Group Name, Office Location, Department, Company, Branch, etc.). Additionally, the User Administrator is able to query and create lists/reports of Users via either full alphabetical listing and/or queries on the two User created subcategories.

In regards to a Super Administrator, the present invention is preferably configured and operative such that a screen is provided enabling a Super Administrator to assign all of the otherwise Administrative functions whereby any actions they take (e.g., adding or deleting Administrators) will be logged with date, time and action taken. Preferably a log is stored and available to current and all future Super Administrators. Additionally, the present invention is preferably configured and operative such that a Super Administrator is enabled to Activate and deactivate clients by Company. It is to be appreciated that within a Company, Users may be accessed by the two subcategories defined by the Company (this may be group, department, location, etc), also able to sort Users by Admin role. The Super Administrator may segregate active, inactive Companies and trial Companies.

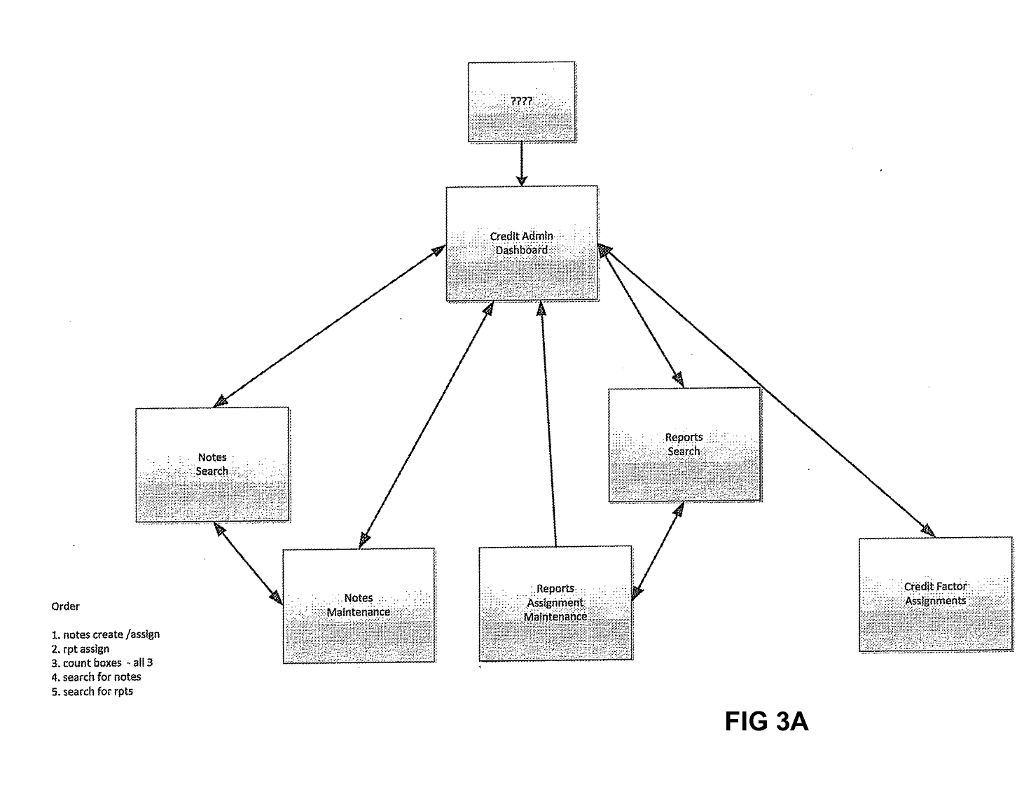

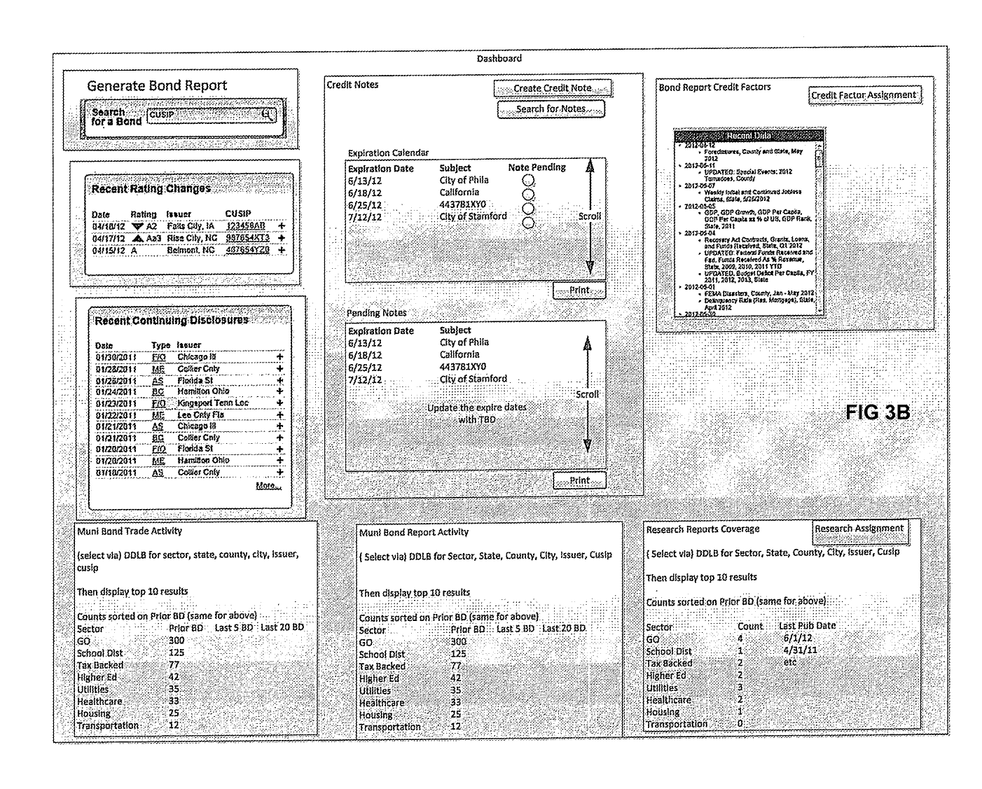

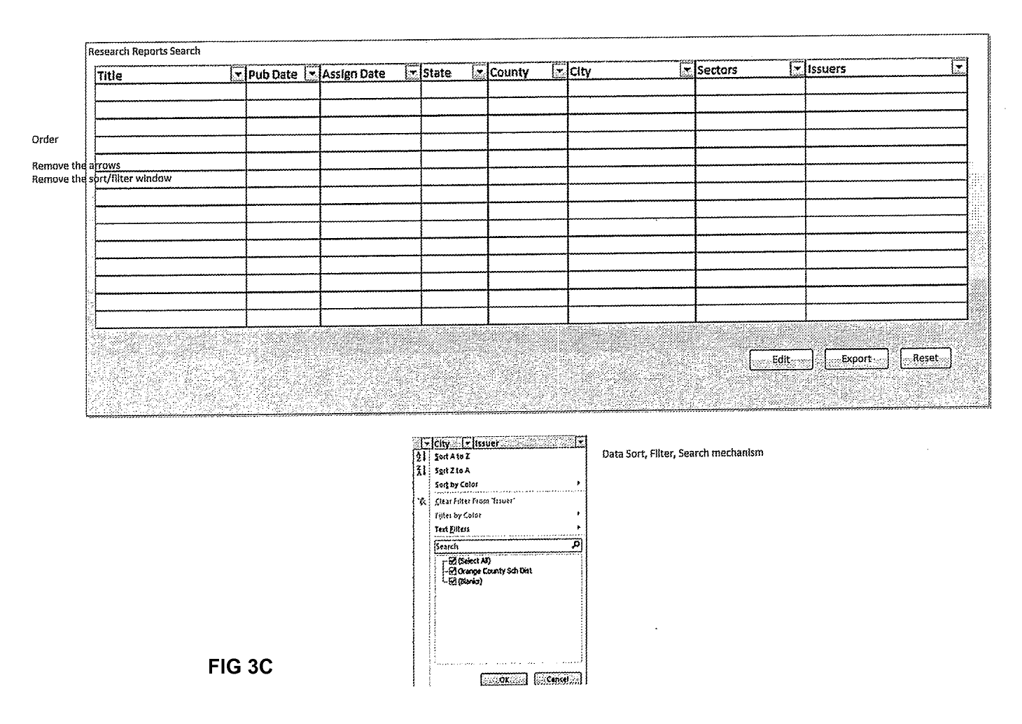

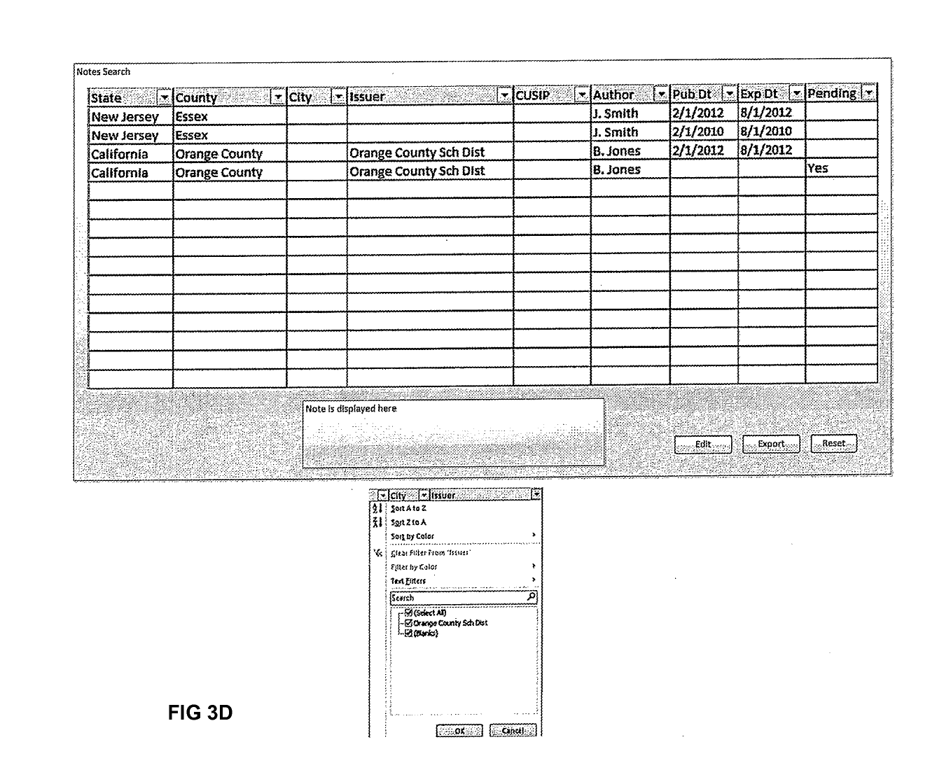

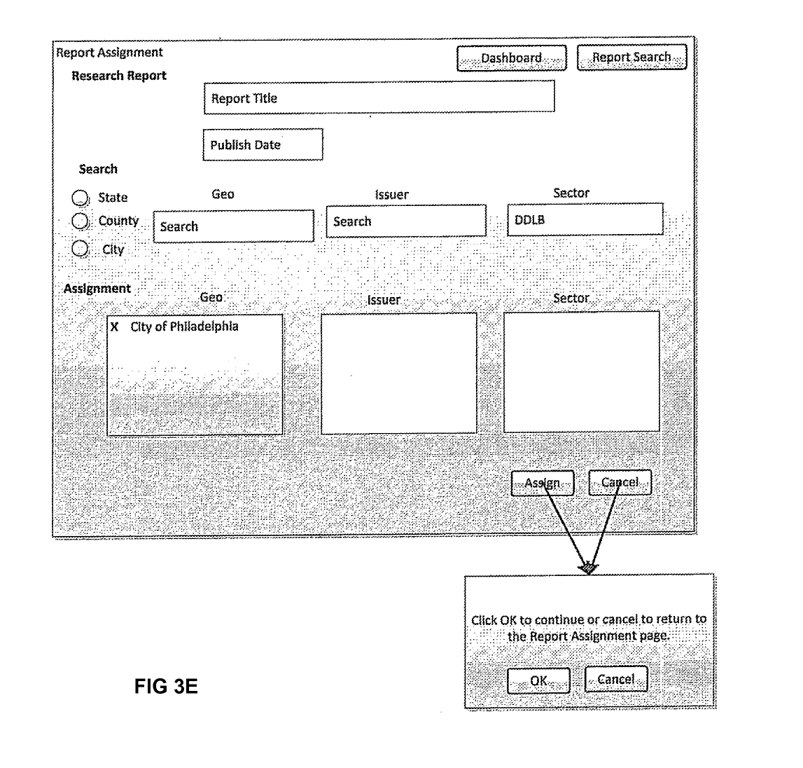

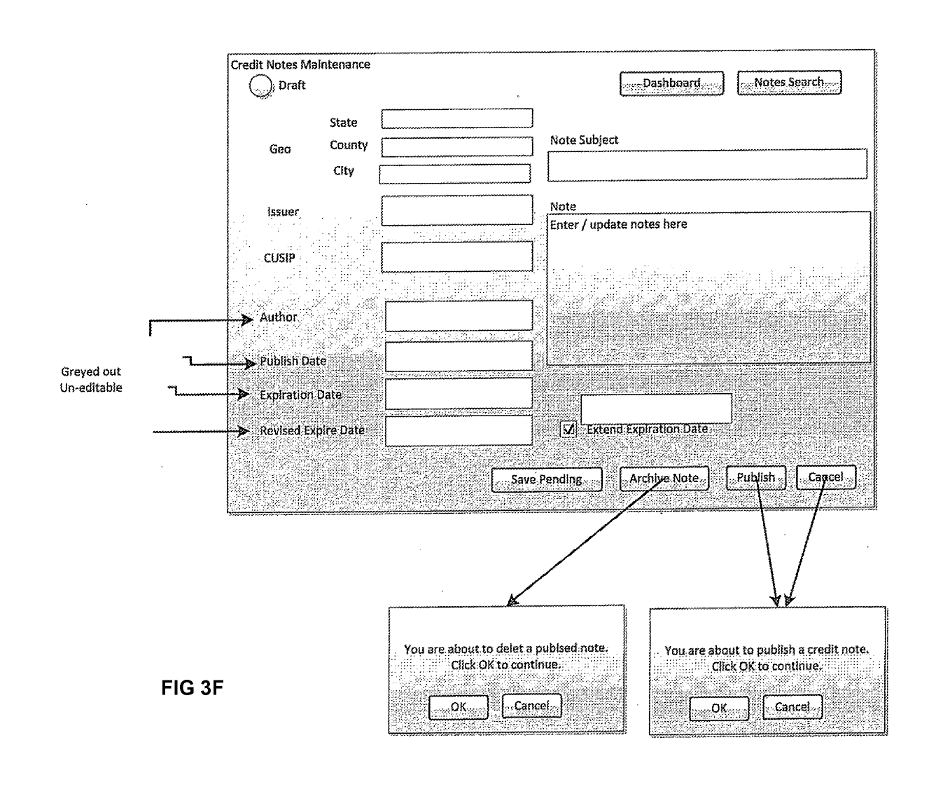

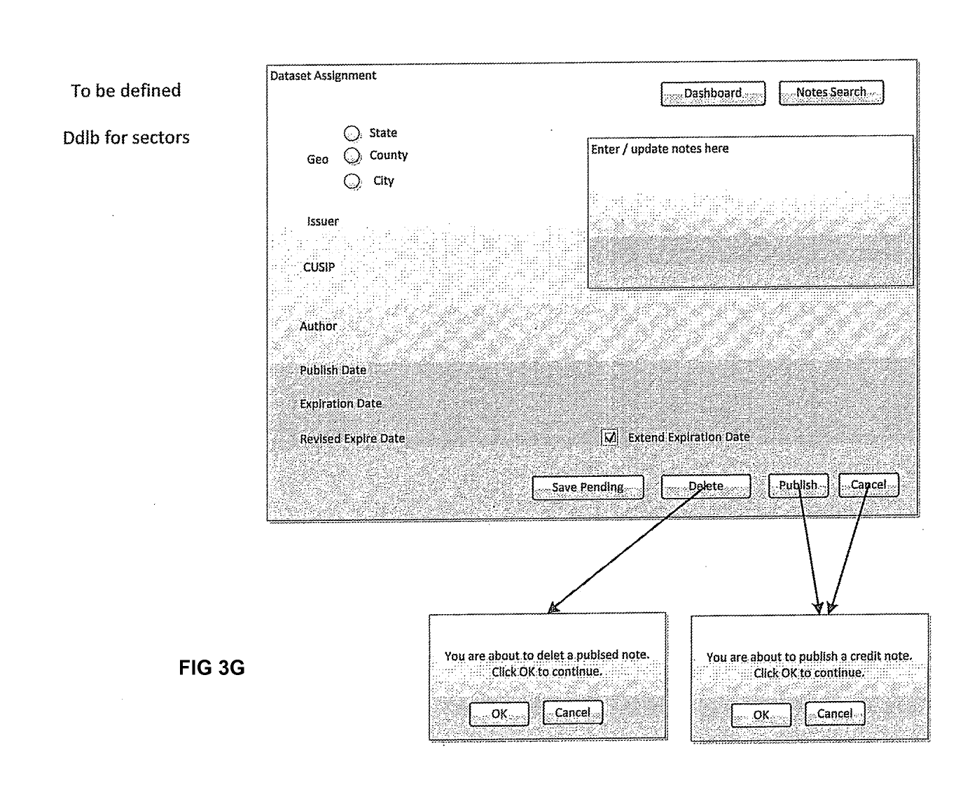

With reference to FIG. 3a, show is a system diagram depicting the operating components of a credit administrator dashboard shown for instance in FIGS. 3B-3G.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

The above presents a description of a best mode contemplated for carrying out the present invention, and of the manner and process of making and using them, in such full, clear, concise, and exact terms as to enable any person skilled in the art to which it pertains to make and use these devices and methods. The present invention is, however, susceptible to modifications and alternative method steps from those discussed above that are fully equivalent. Consequently, the present invention is not limited to the particular embodiments disclosed. On the contrary, the present invention wireless landing gear system encompasses all modifications and alternative constructions and methods coming within the spirit and scope of the present invention.

The descriptions above and the accompanying drawings should be interpreted in the illustrative and not the limited sense. While the invention has been disclosed in connection with the preferred embodiment or embodiments thereof, it should be understood that there may be other embodiments which fall within the scope of the invention as defined by the following claims. Where a claim, if any, is expressed as a means or step for performing a specified function, it is intended that such claim be construed to cover the corresponding structure, material, or acts described in the specification and equivalents thereof, including both structural equivalents and equivalent structures, material-based equivalents and equivalent materials, and act-based equivalents and equivalent acts.

What is claimed is:

1. A method of managing information related to compliance and credit attribution for fixed income securities using a computer system and a computer communication network, comprising:
employing the computer system and communication network to:
identify CUSIP information for securities included in a user fixed income security portfolio;
retrieve bond attribute information for the identified CUSIP information along with economic and demographic data;
identify risk credit notices for the identified GUS IF information; and
generate a user report indicating the retrieved bond attribute information, economic and demographic data and identified risk credit notices for the identified GUS IF information.

2. A method of managing information related to compliance and credit attribution for fixed income securities as recited in claim 1 wherein the information retrieved for the identified CUSIP information is selected from the group consisting of: Obligor debt O/S; Official Statement link from EMMA; disclosures from EMMA; EMMA financial and operating filings; material events filings from EMMA; and links to local, county and State news sources covering the geography associated with the identified CUSIP information. retrieve disclosure material from EMMA using identified CUSIP information for securities included in the user entered fixed income security portfolio; and provide the retrieved disclosure material in an electronic notification to the user.

3. A method of managing information related to compliance and credit attribution for fixed income securities as recited in claim 1 wherein the generated report provides sectors and sub-sectors for the identified CUSIP information.

4. A method of managing information related to compliance and credit attribution for fixed income securities as recited in claim 3 wherein the generated report includes 6 digit CUSIPs mapped to at least a sector and sub-sector for the identified CUSIP information.

5. An Internet-based system for facilitating managing information related to compliance and credit attribution for fixed income securities, the system comprising:
a website coupled to a website server;
a computer system coupled to the website server, the computer system having a processor configured to issue a plurality of instructions stored in memory, wherein the instructions issue signals to:
identify CUSIP information for securities included in a user fixed income security portfolio;
retrieve bond attribute information for the identified CUSIP information along with economic and demographic data;
identify risk credit notices for the identified CUSIP information; and
generate a user report indicating the retrieved bond attribute information; economic and demographic data and identified risk credit notices for the identified CUSIP information.

6. An Internet-based system for facilitating managing information related to compliance and credit attribution for fixed income securities as recited in claim 5 wherein the information retrieved for the identified CUSIP information is selected from the group consisting of: Obligor debt O/S; Official Statement link from EMMA; disclosures from EMMA; EMMA financial and operating filings; material events filings from EMMA; and links to local, county and State news sources covering the geography associated with the identified CUSIP information.

7. An Internet-based system for facilitating managing information related to compliance and credit attribution for fixed income securities as recited in claim 5 wherein the generated report provides sectors and sub-sectors for the identified CUSIP information.

8. An Internet-based system for facilitating managing information related to compliance and credit attribution for fixed income securities as recited in claim 7 wherein the generated report includes 6 digit CUSIPs mapped to at least a sector and sub-sector for the identified CUSIP information.
